(19) United States
(12) Patent Application Publication
(10) Pub. No.: US 2003/0024162 A1
(43) Pub. Date: Feb. 6, 2003

(54) Shape sustaining pot cover and method for producing same

(76) Inventor: Donald E. Weder, Highland, IL (US)

Correspondence Address: DUNLAP, CODDING & ROGERS P.C., PO BOX 16370, OKLAHOMA CITY, OK, 73114, US

(21) Appl. No.: 10/263,572

(22) Filed: Oct. 2, 2002

Related U.S. Application Data
(63) Continuation of application No. 09/584,304, filed on May 31, 2000, now abandoned.
Application No. 09/584,304 is a continuation of application No. 09/146,808, filed on Sep. 4, 1998, now abandoned.
(60) Provisional application No. 60/059,345, filed on Sep. 19, 1997.

(51) Int. Cl. A01G 9/02

(52) U.S. Cl. 47/72

(57) ABSTRACT

A low cost preformed, shape sustaining pot cover and method for producing same from non-shape sustaining materials wherein the non-shape sustaining materials are a single ply film material having a thickness of less than about 0.9 mil, more desirably from about 0.6 to about 0.85 mil, which is capable of being heat sealed and which will not maintain or hold a predetermined formed shape under normal, usual conditions.

### CROSS REFERENCE TO RELATED APPLICATIONS

This application is a continuation of U.S. Ser. No. 09/584,304, filed May 31, 2000, entitled “SHAPE SUSTAINING POT COVER AND METHOD FOR PRODUCING SAME;” which is a continuation aof U.S. Ser. No. 09/146,808, filed Sep. 4, 1998, entitled SHAPE SUSTAINING POT COVER AND METHOD FOR PRODUCING SAME,” now abandoned; which claims benefit under 35 U.S.C. 119(e) of U.S. Provisional application Serial No. 60/059,345, filed Sep. 19, 1997, entitled “SHAPE SUSTAINING POT COVER AND METHOD FOR PRODUCING SAME,” the contents of all of the above are hereby expressly incorporated herein in their entirety by reference.

### STATEMENT REGARDING FEDERALLY SPONSORED RESEARCH OR DEVELOPMENT

Not applicable.

### FIELD OF THE INVENTION

1. Background of the Invention

The present invention relates generally to a preformed, shape sustaining pot cover and method for producing same, and more particularly, but not by way of limitation, to a low cost preformed, shape sustaining pot cover and method for producing same from non-shape sustaining materials.

### BRIEF DESCRIPTION OF THE DRAWINGS

FIG. 1 is a perspective view of a preformed, shape sustaining pot cover constructed in accordance with the present invention.

FIG. 2 is a perspective view of the preformed, shape sustaining pot cover of FIG. 1 having a flower pot disposed therein.

FIG. 3 is a perspective view of a sheet of non-shape sustaining material employed to produce the preformed, shape sustaining pot cover of FIG. 1.

FIG. 4 is a diagrammatic, cross-sectional view of male mold and a female mold of a forming system for forming the preformed, shape sustaining pot cover of FIG. 1 from the sheet of the non-shape sustaining material of FIG. 3.

### DESCRIPTION OF THE PREFERRED EMBODIMENTS

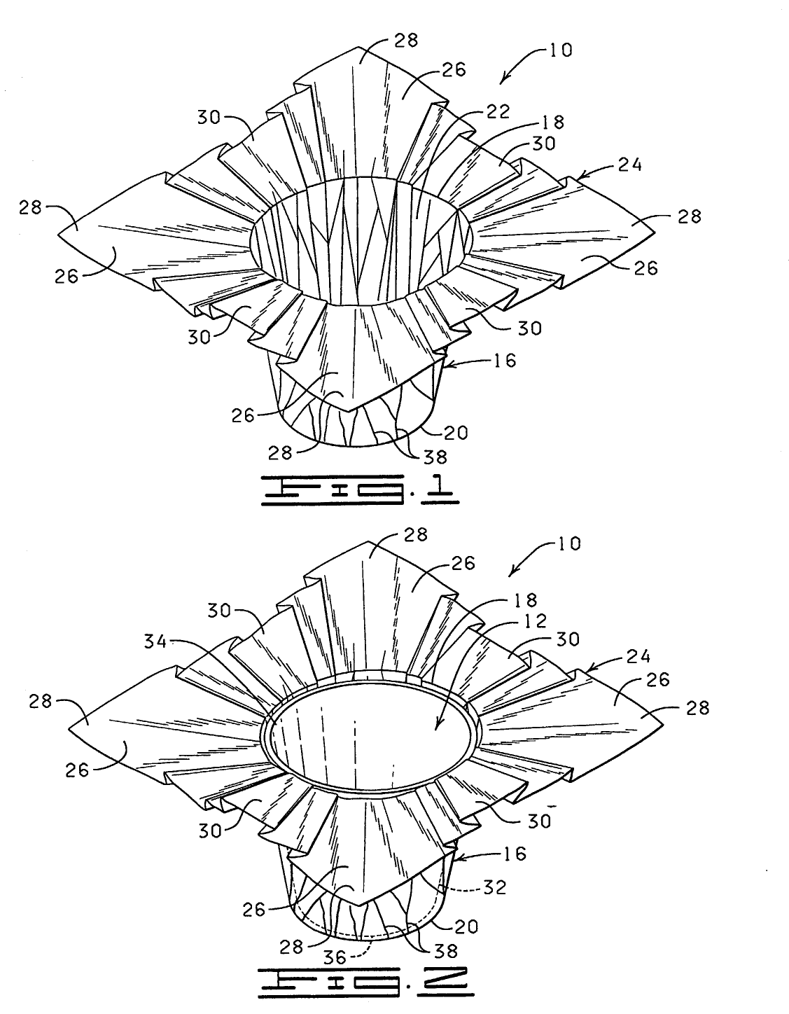

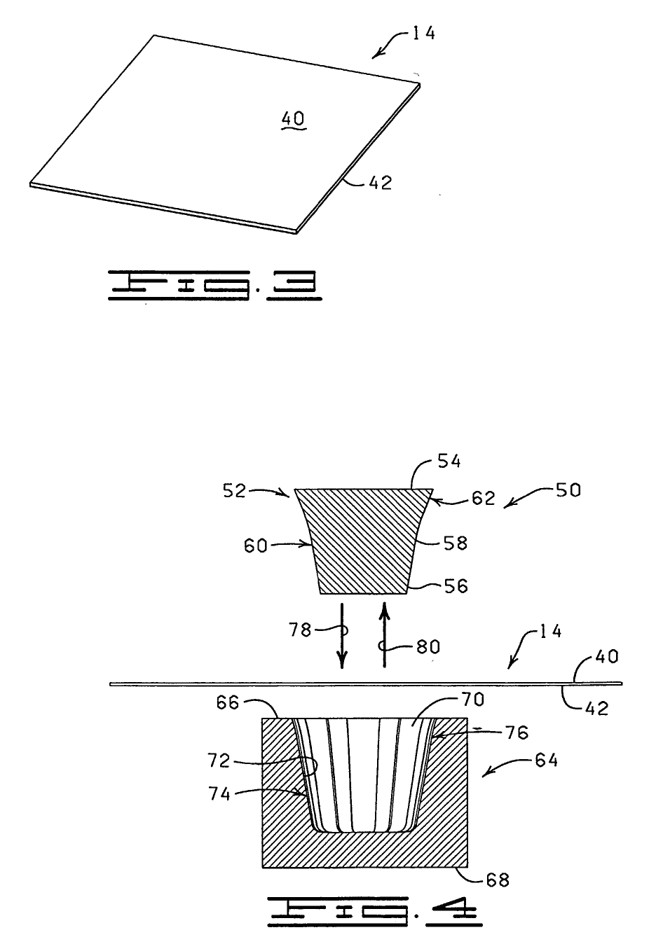

Shown in FIGS. 1 and 2 is a decorative preformed, shape sustaining pot cover 10 for a flower pot 12, the decorative preformed, shape sustaining pot cover 10 being constructed from a sheet of material 14 (FIG. 3) in accordance with the present invention. The sheet of material 14 contemplated for use in the production of the decorative preformed, shape sustaining pot cover 10 is a single ply film material which is capable of being heat sealed and which will not maintain or hold a predetermined formed shape under normal, usual conditions (i.e, the sheet of material 14 is a single ply, non-shape sustaining material). Further, the single ply film material has a thickness of less than about 0.9 mil, and more desirably from about 0.6 to about 0.85 mil.

The decorative, preformed shape sustaining pot cover 10 preferably, although not exclusively, is formed from a generally square-shaped sheet of material 14 having four corners. As shown in FIGS. 1 and 2, the decorative, preformed shape sustaining pot cover 10 formed from the generally square-shaped sheet of material 14 in accordance with the present invention includes a base 16 having an open upper end 18, a closed lower end 20, a pot receiving cavity 22 extending from the open upper end 18 to the closed lower end 20 and a decorative border or skirt 24 which extends angularly upwardly and outwardly from the open upper end 18 of the base 16. The decorative border 24 includes four accentuated and sculptured flared petal-like portions 26, each flared petal-like portion 26 terminating with a pointed end 28 which is formed by one of the four corners of the square-shaped sheet of material 14. Each flared petal portion 26 extends a distance angularly upwardly and outwardly from the upper end 18 of the base 16 and terminates with the pointed end 28. The flared petal-like portions 26 are spaced apart circumferentially about the decorative border 24 with the flared petal-like portions 26 being spaced at about ninety degree intervals. A flared connecting portion 30 is disposed between each pair of adjacent flared portions 26. The flared connecting portions 30 extend a distance angularly upwardly and outwardly from the upper end 18 of the base 16 which is less than the distance between the pointed ends 28 of the flared portions 26 and the upper end 18 of the base 16.

The pot receiving cavity 22 of the preformed, shape sustaining pot cover 10 is shaped and sized to receive the flower pot 12. When the flower pot 12 is disposed in the pot receiving cavity 22 of the preformed, shape sustaining pot cover 10, as shown in FIG. 2, the base 16 of the preformed, shape sustaining pot cover 10 substantially encompasses an outer peripheral surface 32 of the flower pot 12 such that the open upper end 18 of the base 16 of the preformed, shape sustaining pot cover 10 is disposed generally near an upper end 34 of the flower pot 12, the closed lower end 20 of the base 16 of the preformed, shape sustaining pot cover 10 is disposed substantially adjacent a lower end 36 of the flower pot 12 and the decorative border or skirt 24 of the preformed, shape sustaining pot cover 10 extends a distance angularly upwardly and outwardly from the upper end 34 of the flower pot 12.

As shown in FIGS. 1 and 2, the base 16 of the decorative preformed, shape sustaining pot cover 10 formed from the sheet of material 14 in accordance with the present invention includes a plurality of overlapping folds 38 (only some of the overlapping folds 38 being designated by a reference numeral in the drawings). A substantial portion of the overlapping folds 38 extend at angles to a vertical direction and at angles to a horizontal direction, the various angles being arbitrary and varying from one overlapping fold 38 to another overlapping fold 38. Thus, the plurality of overlapping folds 38, which are formed at various positions about the outer peripheral surface of the base 16 and at various locations between the open upper 18 and the closed lower end 20 of the base 16, provide an overall decorative appearance to the base 16. However, more significantly, the overlapping folds 38 formed in the base 16 of the decorative preformed, shape sustaining pot cover 10 provide the required structural integrity to the base 16 to enable the base 16 to stand upright on the closed lower end 20 of the base 16 and substantially retain its formed configuration. In this manner, the base 16 of the decorative preformed, shape sustaining pot cover 10 has sufficient mechanical strength to stand upright about the flower pot 12 without the necessity of mechanically connecting the base 16 of the decorative preformed, shape sustaining pot cover 10 to the flower pot 12. Each overlapping fold 38 extends an arbitrary distance and most of the overlapping folds 38 extend at arbitrary angles over the base 16 which enhances the mechanical strength of the base 16 as compared to the mechanical strength which might be imparted to the base 16 by overlapping folds extending only in vertical or horizontal directions.

As shown in FIGS. 3 and 4, the sheet of material 14 employed to produce the decorative preformed, shape sustaining pot cover 10 has an upper surface 40 and a lower surface 42. If desired, a pattern or design can be printed and/or embossed on the upper surface 40 and/or the lower surface 42 of the sheet of material in order to enhance the aesthetics of the decorative preformed, shape sustaining pot cover 10 formed from the sheet of material 14 in accordance with the present invention. Further, if the sheet of material 14 is provided with an embossed pattern or design and a printed pattern or design, the embossed pattern or design can be either in register with, out of register with, or partially in register and partially out of register with the printed pattern or design.

As previously stated, the sheet of material 14 is a single ply film material having a thickness of less than about 0.9 mil, more desirably from about 0.6 to about 0.85 mil which is capable of being heat sealed and which will not maintain or hold a predetermined formed shape under normal, usual conditions (i.e the sheet of material 14 is a heat sealable, non-shape sustaining material). Any single ply film material having the above-identified properties and characteristics can be employed as the sheet of material 14 in the formation of the decorative preformed, shape sustaining pot cover 10. Examples of such materials are polymeric films, such as biaxially oriented polypropylene film, biaxially oriented polypropylene coextruded film, cellophane and the like, and metallized films, such as metallized biaxially oriented polypropylene film, metallized biaxially oriented polypropylene coextruded film and the like.

The overlapping folds 38 formed by overlapping portions of the sheet of material 14 during the formation of the sheet of material 14 into the decorative preformed, shape sustaining pot cover 10 are bondingly connected by heat applied to the sheet of material 14 during the molding process. For esthetic purposes, it is preferable that the decorative border 24 and particularly the flared petal-like portions 26 remain substantially free of bonded overlapping folds. Also, it is desirable that the flared connecting portions 30 also remain substantially free of bonded overlapping folds.

Referring now to FIG. 4, a system 50 for forming the sheet of material 14 into the decorative preformed, shape sustaining pot cover 10 having the above-described characteristics is illustrated. The system 50 includes a male die 52 having an upper end 54 and a lower end 56. A male die surface 58 is formed on the outer peripheral surface of the male die 52 and the male die surface 58 extends a distance generally from the lower end 56 of the male die 52 toward the upper end 54 thereof. A lower or base portion 60 of the male die 52 has a configuration substantially corresponding to the configuration to the outer peripheral surface 32 of the flower pot 12; and an upper portion 62 of the male die 52 flares a distance angularly and outwardly from the lower or base portion 60 of the male die 52. The dimensions of the lower or base portion 60 of the male die 52 is slightly larger than the comparable dimensions of the outer peripheral surface 32 of the flower pot 12 so that the decorative preformed, shape sustaining pot cover 10 formed from the sheet of material 14 utilizing the system 50 will fit generally about the outer peripheral surface 32 of the flower pot 12 substantially as shown in FIG. 2.

The system 50 also includes a female die 64 having an upper end 66 and a lower end 68. The male die 52 is supported a distance generally above and generally aligned with the female die 64. An opening 70 is formed through the upper end 66 of the female die 64 and the opening 70 extends a distance generally toward the lower end 68 of the female die 64. The opening 70 forms a female die surface 72. The opening 70 forming the female die surface 72 is shaped and sized to receive and formingly mate with the male die surface 58 of the male die 52 with a sufficient clearance therebetween to accommodate portions of the sheet of material 14 during the forming of the decorative preformed shape sustaining pot cover 10.

The female die 64 includes a base portion 74 which is substantially frusto-conically shaped. The base portion 74 of the female die 64 is shaped to mate with the lower or base portion 60 of the male die 52 with sufficient clearance therebetween to accommodate portions of the sheet of material 12 during the forming of the decorative cover 14.

The female die 64 also includes a flared portion 76. The flared portion 76 of the female die 64 extends angularly outwardly and upwardly from the base portion 74 of the female die 64. The flared portion 76 of the female die 64 is shaped to mate with the upper portion 62 of the male die 52 with sufficient clearance therebetween to accommodate portions of the sheet of material 12 during the forming of the decorative preformed shape sustaining cover 10.

Heating elements (not shown) are connected to the male die 52; and heating elements (also not shown) are connected to the female die 64. The heating elements (not shown) in the male die 52 and in the female die 64 are connected to a power supply so the heating elements cooperate to heat the male die surface 58 of the male die 52 and the female die surface 72 of the female die 64 to a temperature sufficient to bondingly connect the overlapping folds 38 in the base 16 of the decorative preformed shape sustaining cover 10 produced during the formation of the sheet of material 14 into the decorative preformed shape sustaining cover 10 by the system 50.

In operation, the male die 52 is in a retracted or storage position wherein the male die 52 is disposed a distance above and aligned with the female die 64 substantially as shown in FIG. 4. The male and female die surfaces 58 and 72, respectively, are heated to a predetermined temperature sufficient to bondingly connect the overlapping folds 38 formed in the base 16 of the decorative preformed shape sustaining cover 10 during formation of the decorative preformed shape sustaining cover 10. The sheet of material 14 is then disposed generally over the opening 70 in the female die 64.

After the sheet of material 14 has been positioned over the opening 70 in the female die 64, the male die 52 is moved in a downward direction as indicated by the arrow 78 toward the female die 64. As the male die 52 moves in the downward direction 78, the male die 52 moves to a position wherein the lower end 56 of the male die 52 initially engages the portion of the sheet of material 14 disposed over the opening 70 in the female die 64.

Continued movement of the male die 52 in the downward direction 78 pushes portions of the sheet of material 14 generally into the opening 70 in the female die 64 until the male die 52 is matingly disposed within the female die 64 whereby portions of the sheet of material 14 are disposed generally about the male die surface 58 of the male die 52 and generally between the male die surface 58 of the male die 52 and the female die surface 72 of the female die 64.

When the male die 52 is matingly disposed within the opening 70 of the female die 64, the base portion 74 of the female die 64 cooperates with the lower or base portion 60 of the male die 52 to form the portion of the sheet of material 14 disposed therebetween into the base 16 of the decorative preformed shape sustaining pot cover 10; and the flared portion 76 of the female die 64 cooperates with the upper portion 62 of the male die 52 to form the portion of the sheet of material 14 disposed there-between into the decorative border 24 of the decorative preformed shape sustaining pot cover 10. Once the sheet of material 14 has been formed into the decorative preformed shape sustaining pot cover 10, the male die 52 is moved in the upward direction as indicated by the arrow 80 to the storage position as illustrated in FIG. 4. When the male die 52 has been moved to the storage position, the decorative preformed shape sustaining pot cover 10 is removed from the male die 52 for conditioning the cover forming system 50 to form another decorative preformed shape sustaining pot cover 10.

The surface area of the portions of the sheet of material 14 which is pushed into the base portion 74 of the female die 64 and which is utilized to form the base 16 of the decorative preformed shape sustaining pot cover 10 exceeds the surface area of either the lower or base portion 60 of the male die 52 or the base portion 74 of the female die 64 or the outer peripheral surface 32, including the bottom 36, of the preformed shape sustaining pot cover 10. This excess material utilized to form the base 16 of the decorative preformed shape sustaining pot cover 10 during the forming process is utilized to form the overlapping folds 38 in the decorative preformed shape sustaining pot cover 10. As previously stated, the overlapping folds 38 in the decorative preformed shape sustaining pot cover 10 are bonded together during the forming process by heat applied thereto by the male and female dies 52 and 64, respectively.

A suitable system for forming the decorative preformed shape sustaining pot cover 10 from the sheet of material 14 in accordance with the present invention is disclosed in U.S. Pat. No. 4,773,182 entitled “Article Forming System” issued to Weder et al., on Sep. 27, 1988, which is hereby expressly incorporated herein by reference.

When decorative preformed shape sustaining pot covers 10 are formed from the sheet of material 14 in accordance with the present invention, the decorative preformed shape sustaining covers 10 may be flattened for shipping and storage purposes and thereafter may be unflattened for display or sale or both. That is, the decorative preformed shape sustaining pot covers 10 formed from the sheet of material 14 as hereinbefore described can be unflattened to assume the original preformed shape without any substantial loss of the preformed shape, thereby providing a flexible, yet shape sustaining pot cover. The decorative preformed shape-sustaining pot cover 10 formed from the sheet of material 14 possess several unique characteristics or properties which have not been achievable with the prior art preformed shape-sustaining pot cover. That is, the decorative preformed shape-sustaining pot cover 10 formed from the sheet of material 14 (i.e., a single ply film material having a thickness of less than about 0.9 mil, more desirably from about 0.6 to about 0.85 mil) has a looser appearance which provides the decorative preformed shape-sustaining pot cover 10 with a more gift-wrapped effect, and more efficient production of the decorative preformed shape-sustaining pot cover 10 is attained due to a reduction in the dwell time in the mold assembly during the production of the decorative preformed shape-sustaining pot cover 10.

Changes may be made in the various elements, components, parts and assemblies described herein or in the steps or sequence of steps in the methods described herein without departing from the spirit and scope of the invention as defined in the following claims.

What is claimed:

1. A substantially flexible, shape-sustaining article comprising a base having a closed lower end, an open upper end with an object opening extending therethrough adapted to receive an object and a decorative border extending outwardly from the open upper end of the base, the base of the substantially flexible, shape sustaining article having a plurality of overlapping folds of which at least a portion are connected so as to provide structural integrity to the substantially flexible, shape sustaining article, the substantially flexible, shape-sustaining article being fabricated of a single ply material having a thickness of from about 0.6 mil to about 0.85 mil wherein the single ply material is selected from a group of single ply materials consisting of a biaxially oriented polypropylene film and a biaxially oriented polypropylene coextruded film.

2. The substantially flexible, shape-sustaining article of claim 1 wherein a substantial portion of the overlapping folds in the substantially flexible, shape-sustaining article extend over different distances and at various and arbitrary angles.

3. The substantially flexible, shape-sustaining article of claim 1 wherein the substantially flexible, shape-sustaining article is a flower pot cover.

4. The substantially flexible, shape-sustaining article of claim 1 wherein the decorative border of the substantially flexible, shape-sustaining article is substantially free of permanently connected overlapping folds.

5. The flexible, shape-sustaining article of claim 1 wherein at least one surface of the biaxially oriented polypropylene film or the biaxially oriented polypropylene coextruded film contains printed materials and designs, embossed materials and designs or combinations thereof.

6. The flexible, shape-sustaining article of claim 5 wherein at least one surface of the biaxially oriented polypropylene film or the biaxially oriented polypropylene coextruded film contains a combination of printed materials and designs and embossed materials and designs and wherein at least a portion of the printed materials and designs are in register with the embossed materials and designs.

7. The substantially flexible, shape-sustaining article of claim 1 wherein the single ply material has a thickness of from about 0.6 mil to about 0.85 mil and wherein the single ply material is a metallized biaxially oriented polypropylene film or a metallized biaxially oriented polypropylene coextruded film.

8. The substantially flexible, shape-sustaining article of claim 7 wherein at least one surface of the metallized biaxially oriented polypropylene film or the metallized biaxially oriented polypropylene coextruded film contains printed materials and designs, embossed materials and designs and combinations thereof.

9. The substantially flexible, shape-sustaining article of claim 8 wherein at least one surface of the metallized biaxially oriented polypropylene film or the metallized biaxially oriented polypropylene coextruded film contains a combination of printed materials and designs and embossed materials and designs and wherein at least a portion of the printed materials and designs are in register with the embossed materials and designs.

10. A substantially flexible, shape-sustaining flower pot cover comprising a base having a closed lower end, an open upper end with an object opening extending therethrough adapted to receive an object and a decorative border extending outwardly from the open upper end of the base, the base of the flower pot cover having a plurality of overlapping folds of which at least a portion are permanently connected so as to provide structural integrity to the substantially flexible, shape sustaining flower pot cover, the substantially flexible, shape-sustaining flower pot cover having printed materials and designs, embossed materials and designs, and combinations thereof so that at least a portion of the substantially flexible, shape-sustaining flower pot cover is provided with printed materials and designs, embossed materials and designs, and combinations thereof and wherein the flexible, substantially non-shape sustaining polymeric material comprises:
a single ply polymeric material having a thickness of from about 0.6 mil to about 0.85 mil wherein the single ply material is selected from a group of single ply materials consisting of a metallized biaxially oriented polypropylene film or a metallized biaxially oriented polypropylene coextruded film.
